(19) United States
(12) Patent Application Publication
(10) Pub. No.: US 2025/0207623 A1
(43) Pub. Date: Jun. 26, 2025

(54) HOLDING PLATE FOR MULTIPLE SCREW DIAMETERS

(71) Applicant: EJOT SE & Co. KG, Bad Berleburg (DE)

(72) Inventors: Volker Wagner, Giessen (DE); David Ulbrich, Bad Laasphe-Herbertshausen (DE)

(21) Appl. No.: 18/849,303

(22) PCT Filed: Mar. 22, 2022
(86) PCT No.: PCT/EP2022/057522

§ 371 Date: Sep. 20, 2024

(51) Int. Cl. F16B 43/00; E04D 5/14

(52) U.S. Cl. CPC F16B 43/00; E04D 5/145

(57) ABSTRACT

A holding plate for sheet material is described, the holding plate comprising a disk-shaped plate, and an aperture formed by an inner edge of the disk-shaped plate, wherein the inner edge of the disk-shaped plate has a contour that comprises a plurality of fins, wherein each fin of the plurality of fins extends at least partially towards a center of the aperture, and wherein each of the plurality of fins is configured to allow a bending of the respective fin.

The current application relates to a holding plate for fixing sheet material, in particular insulating material or waterproofing membranes. The holding plate is adapted for use with multiple screw diameters.

A holding plate according to the present invention is a plate that can be attached to a substrate, for example parts of a roof or a wall of a building. By attaching the holding plate to the substrate, the holding plate can fix sheet material to the substrate, wherein the sheet material is placed between the holding plate and the substrate. The sheet material may, for example, be an insulating material or a waterproofing membrane. This allows, for example, the fixing of sheets of insulating material or waterproofing membranes to a roof.

In the art, several holding plates are available that serve the purpose of fixing sheet material to a substrate. Such a holding plate usually consists of a disk-shaped plate made from metal, which comprises an aperture that is configured for receiving a fastening means that is used to attach the holding plate to the substrate. An example of a fastening means may be a screw. In order to fasten a sheet material to a substrate, the holding plate is placed at the site of the sheet material opposite the substrate before the fastening means is installed in the substrate through the aperture of the disk-shaped plate and the sheet material.

In order to achieve a secure attachment of the holding plates known in the art to the substrate, it is necessary to select a fastening means that is adapted for being placed in the aperture of the disk-shaped plate. For example, if the fastening means is a screw, the diameters of the screw's body and head need to match the diameter of the aperture. Further, different types of substrates may require different types of fastening means, which may differ in size. For example, using the holding plate for fixing sheet material to a roof may require other fastening means than fixing sheet material to a wall. Also, even when only considering fixing of sheet material to a roof, different types of fasteners are commonly used in the art, for example roofing fasteners used for wood, steel or concrete. Also, usually several holding plates need to be installed for guaranteeing secure placement of the sheet material, which may cause problems in case that insufficient fastening means of the same type are available.

Additionally, different geographic regions use different unit systems (e.g. metric system, US customary unit system, or British/imperial unit system) and therefore fastening means that have different sizes compared to other unit systems. Accordingly, holding plates as known in the art are also different in some geographic regions, because they need to be adapted to the fastening means that are used. Sometimes, fastening means from different unit systems may be used at the same construction site, which further complicates the compatibility of fastening means and holding plates.

Hence, there is a need in the art for improving the handling of holding plates for sheet material.

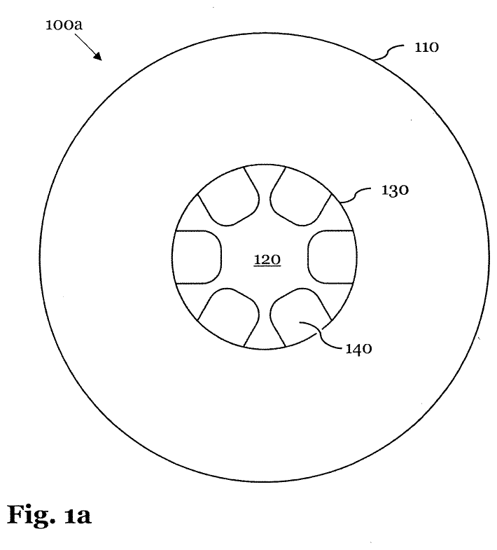

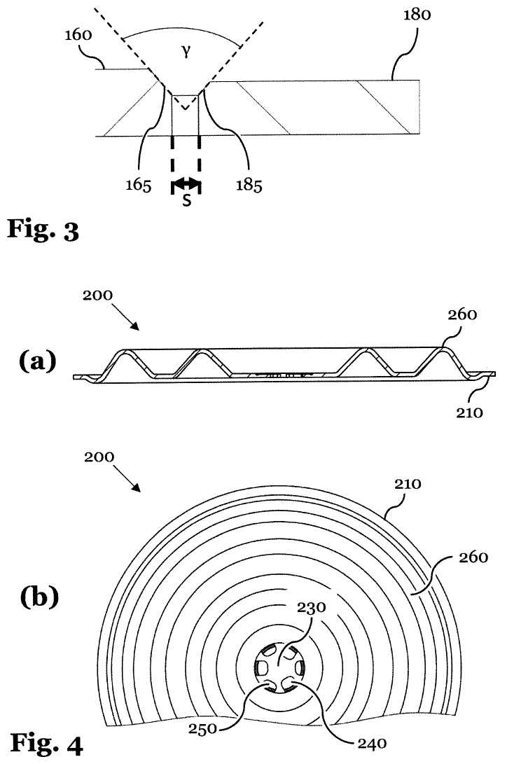

This need is addressed by a holding plate according to the current invention. The holding plate is configured for holding sheet material and comprises a disk-shaped plate and an aperture. The disk-shaped plate may have a certain form. In a top view of the disk-shaped plate, the plate may, for example, be round or rectangular, even though other shapes are also possible. In the figures, a round disk-shaped plate is illustrated, e.g. in FIGS. 1a, 1b. The disk-shaped plate may define a plane. In this plane, the spatial extend of the plate is larger than its thickness (i.e. the extend perpendicular to the plane). For example, if the disk-shaped plate has a circular cross-section, the diameter of the circular plate (i.e. its radial extension) may be larger than its thickness. Alternatively, if the disk-shaped plate has a rectangular cross-section, the edge length of the rectangle may be larger than the thickness of the plate. Also, it needs to be noted that the disk-shaped plate does not necessarily need to be flat. Instead, it may also be possible that the plate has an uneven surface, which for example may be formed by stamped projections, as will be described in more detail with respect to the figures, e.g. FIG. 4. In another example, the plate may have sections with different thicknesses.

The aperture extends through the disk-shaped plate along the entire thickness of the disk-shaped plate. A boundary of the aperture is formed by an inner edge of the disk-shaped plate. The aperture may also be referred to as a hole or a bore. The inner edge of the disk-shaped plate has a contour that comprises a plurality of fins. Each fin of the plurality of fins extends at least partially towards a center of the aperture. A plurality in the sense of the current invention may be two or more. In some preferred embodiments, the plurality of fins may comprise three, six or eight fins.

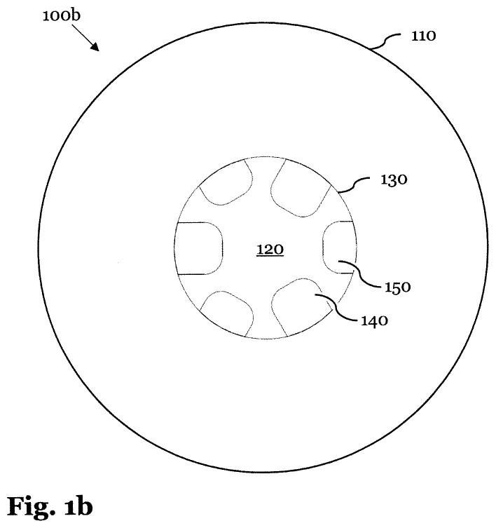

Each fin of the plurality of fins is configured to allow a bending of the respective fin. For example, when a fastening means is inserted into the aperture, some or all of the fins may be bent by the advancing of the fastening means. Depending on the diameter or thickness of the fastening means, the fins may be bent differently. For example, if a fastening means with a large diameter is used, some or all of the fins may be bent substantially, while the fins may be bent only slightly if a fastening means with a small diameter is used. This will be described below in more detail with reference to the figures, especially with respect to FIG. 2.

Bending a fin may be realized as follows: initially each fin of the plurality of fins may be straight or “unbent”. Each fin may extend towards the center of the aperture and may be essentially located within a plane of the disk-shaped plate. Hereinafter, this plane that is used to describe the bending of the fins, will be referred to as reference plane. Such a reference plane may be defined by the disk-shaped plate, for example defined by its cross-section as mentioned above. Alternatively, the reference plane may be parallel and offset to the plane that is defined by the disk-shaped plate. When a fin is bent, the fin is pushed at least partially out of the reference plane, or in other words, the fin is deformed in a way that it extends from the disk-shaped plate in an angle with respect to the reference plane, wherein the angle is non-zero. Depending on the diameter of the fastening means, the fin is deformed differently with respect to the reference plane, meaning that a larger diameter of the fastening means results in the fin extending in a larger angle from the reference plane than when a fastening means with smaller diameter is used.

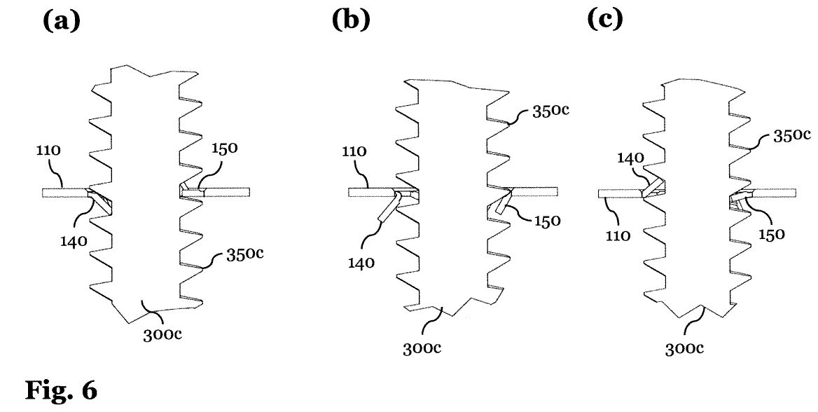

Further, the person skilled in the art will appreciate that each fin of the plurality of fins is bent individually, which means that the extend to which a fin is bent may be different for each fin. The extend may depend on the size of the fastening means that is placed in the aperture, but may also depend on the relative arrangement of the fastening means with respect to the aperture. For example, the fins may be bent differently when a fastening means is placed in the aperture in a way perpendicular to the reference plane than when it is placed in a different angle with respect to the reference plane. Furthermore, the fastening means may comprise a threaded portion that interacts with the plurality of fins and pushes the fins out of the reference plane. In this case, it may be possible that the threaded portion of the fastening means may push different fins out of the reference plane in different directions—for example one fin may be lifted out of the reference plane in a direction towards the rear of the fastening means while another fin may be pushed out of the reference plane in a direction towards the front of the fastening means. This is illustrated in FIG. 6 (c) and will be described in further detail below.

The bending of some or all of the fins allows for a secure placement of the fastening means within the aperture of the disk-shaped plate or—in other words—it allows the disk-shaped plate to securely engage fastening means with different diameters. Hence, a single holding plate may be used with any of a large variety of fastening means. No adaptation of the holding plate is necessary prior to or during use, because the fins themselves adapt to the particular type of fastening means that is used during the assembly. Thereby, the abovementioned need is addressed.

In the following, preferred embodiments are described, which comprise further developments of the abovementioned holding plate.

In a first preferred embodiment, the disk-shaped plate and the plurality of fins may be formed integrally. This allows for a simple design and manufacturing of the holding plate. For example, punching in a punch press is a cost-efficient way of manufacturing a holding plate according to the invention. However, the person skilled in the art will be aware that other manufacturing techniques may also be used.

In another preferred embodiment, the disk-shaped plate may be made of metal. Suitable metals may include steel, stainless steel, carbon steel or the like. Metal may provide substantial structural rigidity for the disk-shaped plate in order to allow the plate to hold the sheet material. Further, in case that the disk-shaped plate and the plurality of fins are formed integrally, manufacturing the disk-shaped plate—and therefore also the plurality of fins—from metal at the same time allows for the possibility of bending the plurality of fins if a force is applied to the fins.

In another preferred embodiment, each of the plurality of fins may comprise a bending portion configured to allow a bending of the respective fin. Providing a bending portion provides the benefit that the location at which each of the plurality of fins is bent, is predetermined, which allows for controlling the bending.

In addition, each fin of the plurality of fins may further comprise a head portion extending from the bending portion towards the center of the aperture. The disk-shaped plate, the bending portion, and the head portion may each have respective thicknesses. For example, the disk-shaped plate may have a first thickness h₁, the head portion may have a second thickness h₂ that is smaller than or equal to the first thickness h₁, and the bending portion may have a third thickness h₃ that is smaller than the second thickness: h₃<h₂≤h₁. In other words, the disk-shaped plate and maybe the head portion have the largest thickness, while the thickness of the bending portion is the smallest of the three thicknesses. Such predetermined thicknesses allow for securing that the fins will be bent at their respective bending portion. Using a smaller thickness for the head portion (i.e. second thickness h₂) than the thickness of the disk-shaped plate (i.e. first thickness h₁) may improve the engagement between the head portion and the fastening means. Preferably, a fastening means with an outer thread is used. Then the thickness h₂ of the head portion should approximately match the distance of the notches of the outer thread in order to provide a secure engagement.

Further preferred, the transition from portions having the first thickness to portions having the third thickness and from portions having the second thickness to portions having the third thickness may be achieved by transition areas, which are referred to as tapering portions hereinafter. For example, each fin may further comprise a body portion. The bending portion of a fin may extend from the body portion or—in other words—the bending portion is connected to the disk-shaped plate via a body portion. The body portion may comprise a first tapering portion in which the thickness is gradually reduced from the first thickness h₁ to the third thickness h₃. Additionally and/or alternatively, the head portion may comprise a second tapering portion in which the thickness is gradually reduced from the second thickness h₂ to the third thickness h₃. The tapering portions may, for example, reduce the thickness in a linear fashion, as is illustrated in FIG. 2 (c), or in other ways, for example, step-wise or in a curved fashion. For example, the curved fashion may be modelled by a spline (e.g. a spline defined by a given radius or a varying radius).

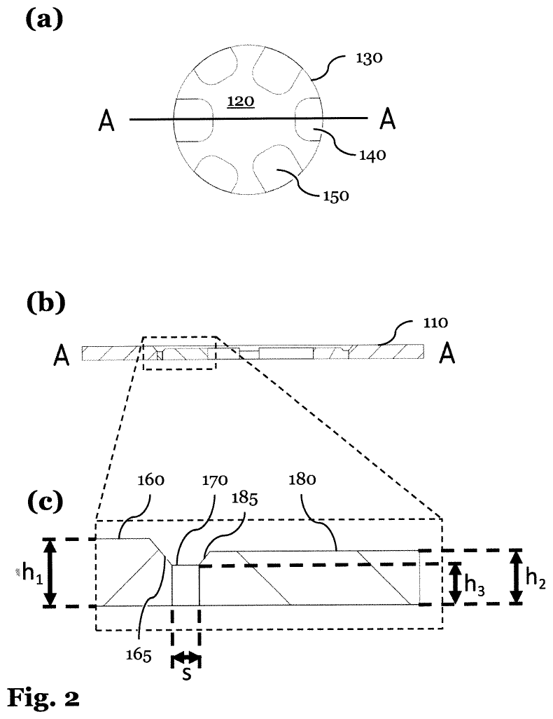

Further, the first and second tapering portions may each comprise a surface. The surfaces of the first and second tapering portions may form an angle γ as is illustrated in FIG. 3. In a preferred example, the angle γ may be approximately 80°.

In some preferred embodiments, the abovementioned third thickness h₃ may be between 0.008″ and 0.15 (approx. 0.2 mm to 0.38 mm). More preferred, the third thickness may be between 0.008″ and 0.012″ (approx. 0.2 mm to 0.3 mm) and even more preferred, the third thickness may be between 0.010″ and 0.012″ (approx. 0.25 mm to 0.3 mm). When the third thickness is in the range between 0.008″ and 0.015″, the fins on the one hand are sufficiently stable for engaging the fastening means, while the force that is necessary for bending the bending portion on the other hand does not exceed a threshold above which the material of the fin may damage the fastening means (for example damaging the coating of the fastening means, which would reduce protection from corrosion).

Further, the first thickness h₁ may be between 0.02″ and 0.04″ (approx. 0.5 to 1 mm) and the second thickness h₂ may be between 0.015″ and 0.04″ (approx. 0.4 to 1 mm).

In a particularly preferred example, the first thickness may be h₁=0.02″ (approx. 0.5 mm), the second thickness may be h₂=0.015″ (approx. 0.4 mm) and the third thickness may be h₃=0.009″ (approx. 0.23 mm).

In another particularly preferred example, the first thickness may be h₁=0.04″ (approx. 1.0 mm), the second thickness may be h₂=0.015″ (approx. 0.4 mm) and the third thickness may be h₃=0.009″ (approx. 0.23 mm)

The abovementioned bending portion may have a length of at least 0.008″ (approx. 0.2 mm). The length may represent the distance between the body portion and the head portion of a respective fin. In other words, the body portion is directly connected to the bending portion, which is then directly connected to the head portion of the respective fin. The bending portion may then be defined by an area formed by said length and the width of the respective fin. Such an area with a length of at least 0.008″ improves the bending behavior as it allows the material to bend out of the plane along said length and the length will be long enough that the material will not break. For example, after manufacturing the holding plate, the bending portion may be straight. When a suitable fastening means is placed within the aperture of the holding plate, the bending portion may be bent, which may result in a curved bending portion.

In some preferred examples, the head portion of each fin may have a particular shape. For example, each fin of the plurality of fins may have a shape that is one of round, drop-shaped, or pointed. These shapes may improve the engagement between the head portion of the respective fin and the fastening means. Different shapes may be preferred for different fastening means. Preferably, the shape of the head portion may be configured to securely engage a thread of the fastening means, for example by meshing with the notches of the thread.

In another preferred embodiment, the contour of the inner edge of the disk-shaped plate may comprise at least one additional fin that does not have a bending portion. For example, one or more shorter fins may be provided that do not have a bending portion but instead function as a guide for the fastening means when the fastening means is inserted. Additionally or alternatively, the one or more shorter fins may comprise a predetermined breaking portion that is configured for breaking in case that a fastening means with a diameter that is above a predetermined threshold is inserted into the aperture. Such an embodiment allows for tight engagement of fastening means with small diameter and at the same time prevents that the usage of a fastening means with a large diameter will induce stress that may cause an inelastic deformation of the disk-shaped plate.

In another preferred embodiment, the disk-shaped plate may be round and may have a diameter between 2″ and 3″ (approx. 50 to 75 mm). Preferably, the diameter is one of 2″, 2⅜″, or 3″ (approx. 50 mm, 60 mm, or 75 mm). Alternatively, the disk-shaped plate may be rectangular and may have an edge length between 2″ and 3″ (approx. 50 to 75 mm). Preferably, the edge length is one of 2″, 2⅜″, or 3″ (approx. 50 mm, 60 mm, or 75 mm). If the disk-shaped plate is rectangular, one or all edge lengths may be in these ranges. The skilled person will appreciate that a rectangular disk-shaped plate may have chamfered corners without departing from the disclosed teaching. Additionally, the term “rectangular” as used in this application refers to quadrilateral shapes and therefore also encompasses shapes that are square, trapezoidal, diamond-shaped, rhomboid or similar shapes. Additionally, other polygonal shapes may also be possible without departing from the disclosed teaching. As the person skilled in the art will appreciate, round and rectangular shapes are the most common, which is why these terms are used for reasons of simplification of the used wording. Irrespective of the shape of the disk-shaped plate, the aperture may have a diameter of 0.2″ to 0.32″ (approx. 5.0 mm to 8.1 mm).

In another preferred embodiment, each fin of the plurality fins may have the same geometry.

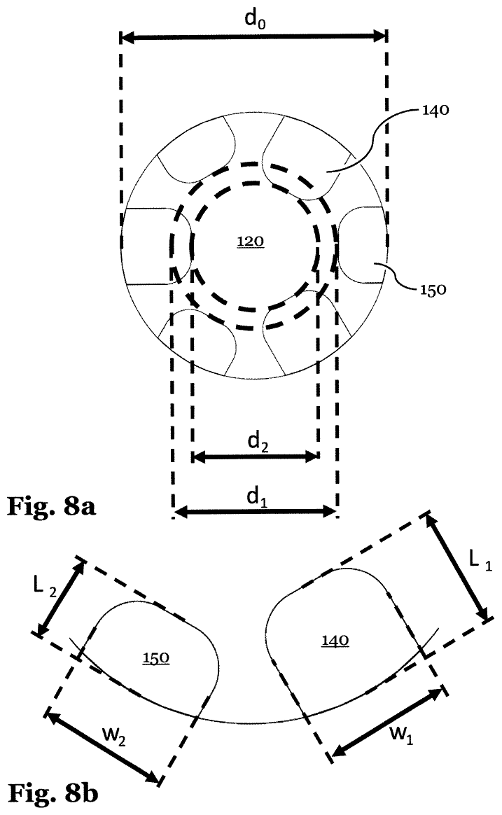

In another preferred embodiment, the plurality of fins may be referred to as a first plurality of fins and the contour of the inner edge of the disk-shaped plate of the holding plate may further comprise a second plurality of fins. The fins of the first plurality of fins may have a different geometry than the fins of the second plurality of fins. Further, the fins of the first plurality of fins may have a length that is different from the length of the fins of the second plurality. The length may be defined as the extend of the respective fin towards the center of the aperture, as will be described in more detail with respect to FIG. 8. Preferably, each fin of the first plurality of fins may have a length of 0.06″ to 0.08″ (approx. 1.5 mm to 2 mm), more preferably 0.07″ (approx. 1.85 mm), and each fin of the second plurality of fins may have a length of 0.04″ to 0.06″ (approx. 1 mm to 1.5 mm), more preferably 0.05″ (approx. 1.3 mm).

Further, the first plurality of fins and the second plurality of fins may preferably each comprise at least three fins. In a particularly preferred example, the first plurality of fins and the second plurality of fins may each comprise exactly three fins. The fins of the first and second pluralities of fins may be distributed alternately along the contour of the edge, meaning that along the contour of the edge of the disk-shaped plate, a fin of the first plurality has, on either side, a neighbor belonging to the second plurality of fins and a fin of the second plurality has, on either side, a neighbor belonging to the first plurality.

In another preferred embodiment, also a first plurality of fins and a second plurality of fins may be provided. In case of the first plurality of fins, each fin may comprise a bending portion, whereas in case of the second plurality of fins, each fin may comprise a predetermined breaking portion that is configured for breaking in case that a fastening means with a diameter that is above a predetermined threshold is inserted into the aperture. Such an embodiment allows for tight engagement of fastening means with small diameter and at the same time prevents that the usage of a fastening means with a large diameter will induce stress that may cause an inelastic deformation of the disk-shaped plate.

The skilled person will appreciate that the abovementioned embodiment examples are not mutually exclusive. Instead, several combinations of the abovementioned embodiment examples may belong to the current invention. For example, the embodiments describing the two or more pluralities of fins may be combined with the embodiments specifying the geometric details of the portions that each fin may have and the respective thicknesses. In this case, the first to third thicknesses of the fins of a first plurality may be different from the first to third thicknesses of the fins of a second plurality of fins.

Further, it needs to be noted that the numerical values that are given herein, are to be understood as approximate values, since each manufacturing process will be subject to manufacturing tolerances.

The following description and the annexed drawings set forth in detail certain illustrative aspects of the apparatus described above. These aspects are indicative, however, of but a few of the various ways in which the principles of various embodiments can be employed and the described embodiments are intended to include all such aspects and their equivalent.

In the drawings, like reference characters generally refer to the same parts throughout the different drawings. The drawings are not necessarily to scale, emphasis instead generally being placed upon illustrating the principles of the invention.

In the following description, various embodiments of the invention are described with reference to the following drawings, in which:

FIG. 1 show top views of two embodiment examples of holding plates according to the current invention, wherein the first embodiment comprises a first plurality of fins, whereas the second embodiment comprises first and second pluralities of fins having different geometries;

FIG. 2 shows a detail view of the aperture of a holding plate according to the current invention, wherein the fins are formed by two pluralities of fins, wherein the two pluralities of fins have different geometries;

FIG. 3 shows a detail view of the geometry of an exemplary fin of one plurality of fins of the holding plate according to the current invention;

FIG. 4 shows another embodiment of a holding plate according to the current invention;

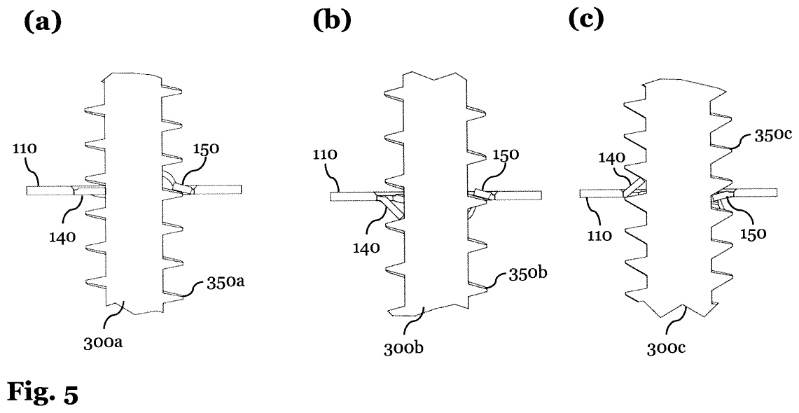

FIG. 5 shows bending of two exemplary fins for fastening means with different sizes;

FIG. 6 shows bending of two exemplary fins for the same fastening means, but the outer thread of the fastening means was inserted in different angles with respect to the fins;

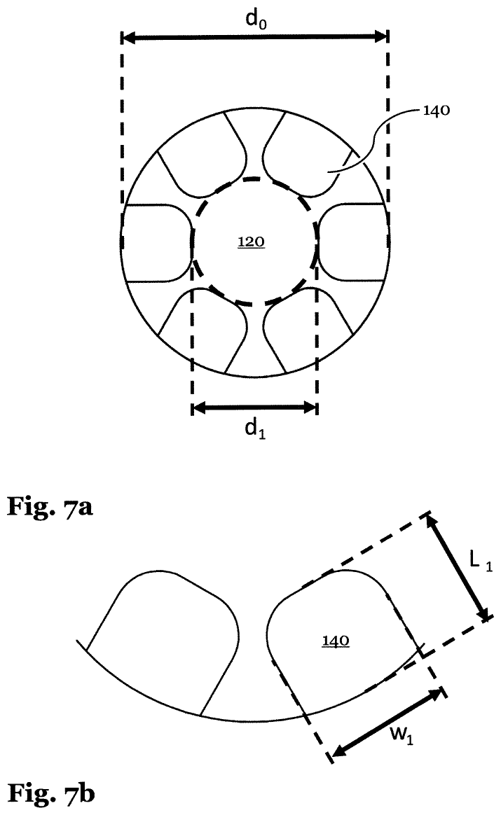

FIG. 7 shows a detail view of the aperture of the holding plate according to FIG. 1a with emphasis on the geometry of the plurality of fins;

FIG. 8 shows a detail view of the aperture of the holding plate according to FIG. 1b with two pluralities of fins having different geometries;

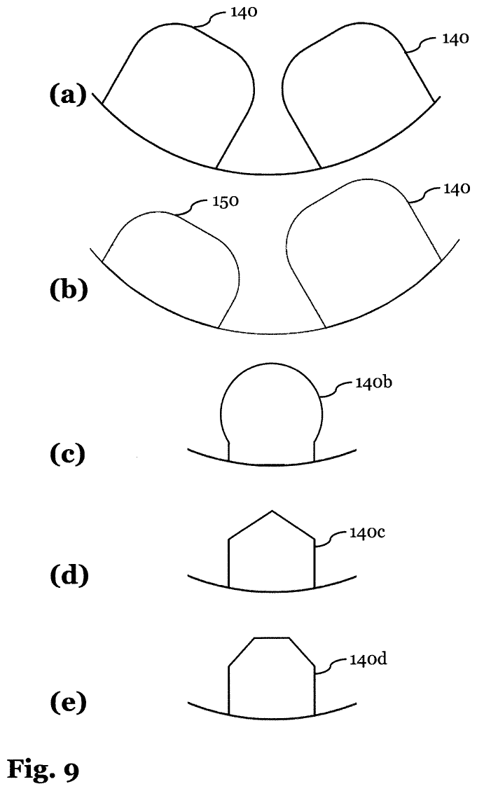

FIG. 9 shows different geometries of fins according to the current invention;

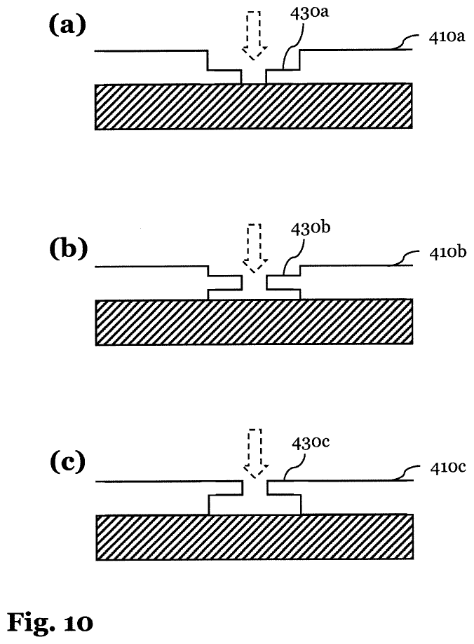

FIG. 10 shows different concepts of thickness reduction of the plurality of fins for three embodiment examples of holding plates according to the current invention.

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

FIG. 1 show top views of two embodiment examples of holding plates according to the current invention, wherein the first embodiment comprises a first plurality of fins (FIG. 1a) whereas the second embodiment comprises first and second pluralities of fins (FIG. 1b), wherein the two pluralities of fins have different geometries.

In FIG. 1a, an embodiment of a holding plate according to the current invention is generally shown at 100a. The holding plate 100a comprises a disk-shaped plate 110 and an aperture 120 that is formed by an inner edge 130 of the disk-shaped plate 110. A contour of the inner edge 130 forms a plurality of fins 140. In the embodiment of the holding plate 100a that is depicted in FIG. 1a, a single plurality of fins 140 is illustrated, wherein the plurality of fins comprises six fins that each have a similar geometry.

In FIG. 1b, an embodiment of a holding plate according to the current invention is generally shown at 100b. The holding plate 100b comprises a disk-shaped plate 110 and an aperture 120 that is formed by an inner edge 130 of the disk-shaped plate 110. A contour of the inner edge 130 forms a plurality of fins 140, 150. In the embodiment of the holding plate 100 that is depicted in FIG. 1, two pluralities of fins 140, 150 are illustrated, wherein each plurality comprises three fins.

FIG. 2 shows a detail view of the aperture 120 of a holding plate according to the current invention, wherein the fins are formed by two pluralities of fins 140, 150, wherein the two pluralities of fins 140, 150 have different geometries. In (a) a detail view of the aperture and the pluralities of fins of the embodiment that is depicted in FIG. 1 is shown. In (b) a cross-section along the line A-A of FIG. 2 (a) is shown and (c) shows an enlarged view of a detail shown in the cross-section of FIG. 2 (b).

In the detail view in (b) and (c), the body portion 160, the bending portion 170, and the head portion 180 of a fin are shown. The body portion 160 is connected to the disk-shaped plate 110 and comprises a first tapering portion 165. The first tapering portion 165 is connected to the bending portion 170. Further, the head portion 180 comprises a second tapering portion 185, which is also connected to the bending portion 170. This way, the bending portion 170 is connected to the body portion 160, which may have essentially the same thickness as the disk-shaped plate, by ease of a transition area in form of the first tapering portion 165. In this transition area, the thickness is gradually reduced from the thickness h₁ of the body portion 160 to the lower thickness h₃ of the bending portion 170.

Similarly, the bending portion 170 is connected to the head portion 180 by ease of another transition area formed by the second tapering portion 185. The second tapering portion 185 provides for a gradually increasing thickness from the low thickness of the bending portion 170 to the larger thickness of the head portion 180. In the depicted embodiment example, the thickness reduction is linear, but as the person skilled in the art will understand, the reduction could also be realized by other means, such as step-wise.

Also, the extend of the bending portion 170 is illustrated. As can be seen, the bending portion is not infinitesimally small, but instead may have particular length s by which it separates the second tapering portion 185 of the head portion 180 from the first tapering portion 165 of the body portion 160. In preferred embodiments, the length of the bending portion 170, which may also be referred to as the extend of the bending portion 170 in the direction towards to the center of the aperture may be around at least 0.008″ (approx. 2 mm). Such a length allows for a bending of the bending portion and prevents the bending portion from breaking in case that the force acting on the bending portion by the insertion of the fastening means into the aperture is high.

Further, the thicknesses h₁, h₂, and h₃ are illustrated, wherein the first thickness h₁ is the thickness of the body portion 160, the second thickness h₂ is the thickness of the head portion 180 and the third thickness h₃ is the thickness of the bending portion 170. The abovementioned ratio of h₃<h₂≤h₁ is also given in the illustrated embodiment example.

FIG. 3 shows a detail view of the geometry of an exemplary fin of the plurality of fins of the holding plate according to the current invention. In the preferred embodiment that is depicted in FIG. 3, both the first tapering portion 165 and the second tapering portion 185 provide a linear reduction/increase in thickness. This way, an angle γ is formed between these tapering portions. The angle γ improves the bending behavior of the fins in case that a fin may be lifted out of the reference plane in a direction towards the rear of the fastening means as was described above—in FIG. 3, this direction may be the direction towards the upper end of the sheet. As can be seen in the figure, when the fin is lifted in this direction, the head portion 180 of the fin will be rotated towards the body portion 160. Because of the tapering portions 165, 185, the head portion 180 may be bent for more degrees because the head portion 180 may eventually be pushed against the body portion 160, for example by the tapering portion 185 being pushed against the tapering portion 165.

The angle γ may depend on the size s and thickness h₃ of the bending portion 170. Preferably, the size is s=0.008″ (approx. 0.2 mm) and the angle γ is approx. 80°. This geometry allows a bending of the bending portion 170, which reduces the stress acting on the material of the bending portion 170, thereby avoiding breaking of the bending portion 170. The angle γ may, however, be smaller—for example γ=60°—which may require an increase in the size s of the bending portion 170.

FIG. 4 shows in (a) a cross-section and in (b) a top view of another embodiment of a holding plate 200 according to the current invention. As was mentioned earlier, the disk-shaped plate 210 does not need to be formed by a flat disk as was illustrated in FIGS. 1 and 2. Instead, it may be possible that the plate 210 has an uneven surface, which for example may be formed by stamped projections 260 as it is illustrated in FIG. 4. Such a structure improves the stability of the disk-shaped plate and allows the plate to withstand higher forces. The holding plate 200 may comprise an aperture 230 and one or more pluralities of fins 240, 250, which are similar to what was described with respect to the holding plate 100a, 100b depicted in FIGS. 1 and 2.

FIG. 5 shows bending of two exemplary fins for fastening means with different sizes. Fastening means of three different sizes are shown in FIG. 5 (a) to (c), wherein the fastening means 300a shown in (a) has the smallest size and the fastening means 300c shown in (c) has the largest size. For the fastening means 300a with the lowest size depicted in (a), the fins are only slightly bent and provide a tight fit around the fastening means 300a. In contrast, the fins for the larger sizes shown in (b) and (c) are more severely bent and forced out of their alignment in the reference plane.

FIG. 6 shows bending of two exemplary fins for the same fastening means. However, in this case, the outer thread of the fastening means 300c was inserted in different angles with respect to the fins, which means that the relative position of the outer thread of the fastening means with respect to the fins is different. As a result, the fins are bent differently in each part of FIG. 6. For example, the right fin 150 in (a) was not bent at all, while the left fin 140 in the same figure was bent substantially. In FIG. 6 (c), both fins 140, 150 were bent more than the right fin 150 in (a), but less than the left fin 140 in (a), whereas in (b) both fins 140, 150 were substantially bent. Hence, it can be seen from the figures that the severity of the bending does not only depend on the size of the fastening means but also on the alignment of the outer thread of the fastening means and the fins.

Moreover, FIG. 6 (b) illustrates that it is possible that the fins are bent more than 90° with respect to the reference plane and still are able to provide tight engagement with the fastening means without breaking.

FIG. 7a shows a detail view of the aperture of a holding plate according to the current invention with a single plurality of fins 140, while FIG. 7b shows a detail view of two fins of the plurality of fins depicted in FIG. 7a. In the embodiment example illustrated in FIGS. 7a and 7b the plurality of fins 140 comprises a set of six fins, which have essentially the same geometry.

In FIG. 7b, the length L and width w of one fin of the plurality of fins are illustrated. The length L may be defined as the extend of the respective fin towards the center of the aperture. It may be measured from the contour of the aperture to the location of the fin that is farthest apart from the contour. As illustrated in FIG. 7b, the length L may be given as the distance between the contour (represented by the portion of the circle that illustrates the aperture) and the end of the head portion.

The maximum diameter of the aperture is given as d₀. Between the head portions of each fins 140, a circle with diameter d₁ is illustrated in order to illustrate that each fin has the essentially the same length. Based on the abovementioned bending of the fins, a holding plate according to the current invention, which may have the geometry illustrated in FIGS. 7a and 7b, is configured for receiving and tightly engaging fastening means, which have a diameter between d₁, i.e. the diameter of the circle formed between the fins, and d₀, i.e. the maximum diameter of the aperture.

FIG. 8a shows a detail view of the aperture of a holding plate according to the current invention with two pluralities of fins with different geometries, while FIG. 8b shows a detail view of two different fins of the two pluralities of fins depicted in FIG. 7. In the embodiment example illustrated in FIGS. 8a and 8b the first plurality of fins and the second plurality of fins each comprise a set of three fins, wherein the fins of the first plurality 150 have a geometry that is different from the fins of the second plurality 150.

In FIG. 8b, the lengths and widths of one fin of each of the two pluralities of fins are illustrated. The length may be defined as the extend of the respective fin towards the center of the aperture. It may be measured from the contour of the aperture to the location of the fin that is farthest apart from the contour. As illustrated in FIG. 8b, the length L may be given as the distance between the contour (represented by the portion of the circle that illustrates the aperture) and the end of the head portion. As is illustrated in FIG. 8b, the fins 140 of the first plurality of fins have a length L₁ and a width w₁. The fins 150 of the second plurality of fins have a length L₂ and a width w₂. While the lengths of the fins are different, i.e. L₂<L₁, their widths may be different or may be essentially the same.

The sections of the head portions of the three fins of the first plurality 140 extend farther into the aperture than the head portions of the three fins of the second plurality 150. Thereby, the ends of the head portions of the first plurality of fins, which are closest to the center of the aperture, form a circle with a diameter d₂ and the head portions of the second plurality of fins form a circle with a diameter d₁, wherein d₂<d₁. The maximum diameter of the aperture itself is given as d₀. Based on the abovementioned bending of the fins, a holding plate according to the current invention, which may have the geometry illustrated in FIGS. 8a and 8b, is configured for receiving and tightly engaging fastening means, which have a diameter between d₂, i.e. the diameter of the circle formed between the larger fins, and d₀, i.e. the maximum diameter of the aperture.

In a particular embodiment example, the maximum diameter d₀ of the aperture may be d₀=0.28″ (approx. 7 mm). The lengths of the fins may be L₁=0.073″ (approx. 1.85 mm) and L₂=0.051″ (approx. 1.3 mm). Such an embodiment of a holding plate is configured for receiving fastening means, which have a diameter smaller than d₀. In order to provide a tight engagement between the fins and the fastening means, the fastening means preferably has a diameter between 0.19″ (approx. 4.8 mm) and 0.28″ (approx. 7 mm).

Additionally or alternatively, one or more additional fins may be provided at the contour of the aperture, wherein these one or more additional fins do not comprise a bending portion. Said one or more additional fins are not configured to be bent. In order to distinguish these one or more additional fins from the fins that comprise a bending portion, the one or more additional fins may also be referred to as protrusions. For example, these one or more protrusions may have a length that is smaller than the fins of the plurality of fins. The protrusions may function as guiding points for the fastening means and may not bent. In an example, the one or more protrusions may comprise a breaking point. The breaking point may cause the respective protrusion to break when the force caused by the inserting of the fastening means is larger than a threshold. The threshold may depend on the material used and the thickness reduction at the breaking point.

FIG. 9 shows different geometries of fins according to the current invention. FIGS. 9 (a) and (b) show the fins that are depicted in FIGS. 7b and 8b respectively. The fins illustrated in FIGS. 9 (a) and (b) have head portions with curved corners. Further, FIG. 9 (c) shows another geometry of a fin 140b, which is drop-shaped. FIGS. 9 (d) and (e) show other geometries of fins 140c, 140d, which are pointed and pointed with a flattened tip portion, respectively.

FIG. 10 shows different concepts of thickness reduction of the plurality of fins for three embodiment examples of holding plates according to the current invention.

Each part of FIG. 10 shows a portion of a holding plate placed above a substrate (hatched area). The respective holding plate is illustrated by its disk-shaped plate 410a, 410b, 410c and two exemplary fins 430a, 430b, 430c. Further, an arrow illustrates the direction for inserting a fastening means into the aperture of the holding plate. In all parts of FIG. 10, for illustration purposes, each of the fins has a smaller thickness than the holding plate. However, as explained above, a fin may realize different thicknesses. The purpose of FIG. 10 is to illustrate that the fins could be arranged differently with respect to the holding plate. In FIG. 10 (a), the lower surface of the fins is flush with the lower surface of the holding plate (i.e. the surface of the holding plate that contacts the substrate or in the sheet material attached to the substrate). This corresponds to the arrangement of the fins as shown in FIGS. 2 (b) and (c). In FIG. 10 (c), the upper surface of the fins is flush with the upper surface of the holding plate, while in FIG. 10 (b), neither surface of the fins is flush with any of the surfaces of the holding plate. The skilled person will appreciate that the embodiments of the holding plates depicted in FIGS. 10 (a) and 10 (c) may essentially be the same, such that the holding plate depicted in FIG. 10 (a) may become the holding plate depicted in FIG. 10 (c) if the holding plate is turned upside down. However, it is also possible that the holding plates may comprise bending portions that are different for the embodiments in FIGS. 10 (a) and (c).

The different embodiment examples that are depicted in FIGS. 10 (a) to (c) may each be particularly suited for certain applications, e.g. usages of particular fastening means or substrates.

In the following, further examples are described in order to facilitate the understanding of the invention. In a first further example, a holding plate for holding sheet material is described. The holding plate comprises a disk-shaped plate and an aperture formed by an inner edge of the disk-shaped plate, wherein the inner edge of the disk-shaped plate has a contour that comprises a plurality of fins, wherein each fin of the plurality of fins extends at least partially towards a center of the aperture, and wherein each of the plurality of fins is configured to allow a bending of the respective fin.

In a second example, a holding plate according to the first example is provided, wherein the disk-shaped plate and the plurality of fins may be formed integrally.

In a third example, a holding plate according to the first or second example is provided, wherein the disk-shaped plate is made of metal.

In a fourth example, a holding plate according to any of first to third examples is provided, wherein each of the plurality of fins comprises a bending portion configured to allow the bending of the respective fin.

In a fifth example, a holding plate according to the fourth example is provided, wherein each fin of the plurality of fins further comprises a head portion extending from the bending portion towards the center of the aperture.

In a sixth example, a holding plate according to the fifth example is provided, wherein the disk-shaped plate has a first thickness (h1), the head portion has a second thickness (h2) that is smaller than or equal to the first thickness (h1), the bending portion (170) has a third thickness (h3) that is smaller than the second thickness (h2).

In a seventh example, a holding plate according to the sixth example is provided, wherein each fin further comprises a body portion and wherein the bending portion extends from the body portion.

In an eighth example, a holding plate according to the seventh example is provided, wherein the body portion comprises a first tapering portion in which the thickness is gradually reduced from the first thickness (h1) to the third thickness (h3), and wherein the head portion comprises a second tapering portion in which the thickness is gradually reduced from the second thickness (h2) to the third thickness (h3).

In a ninth example, a holding plate according to the eighth example is provided, wherein the first and second tapering portions each comprise a surface and wherein the surfaces of the first and second tapering portions form an angle of 80°.

In a tenth example, a holding plate according to any of the sixth to ninth example is provided, wherein the third thickness (h3) is between 0.008″ and 0.015″.

In an eleventh example, a holding plate according to the tenth example is provided, wherein the first and second thicknesses (h1, h2) are between 0.02″ and 0.04″.

In a twelfth example, a holding plate according to any of the seventh to ninth example is provided, wherein the bending portion has a length(s) of at least 0.008″ and wherein the length represents the distance between the body portion and the head portion of a respective fin.

In a thirteenth example, a holding plate according to any of the fifth to twelfth example is provided, wherein the head portion of each fin of the plurality of fins comprises a shape that is one of round, drop-shaped, or pointed.

In a fourteenth example, a holding plate according to any of the fourth to thirteenth example is provided, wherein the contour of the inner edge of the disk-shaped plate comprises at least one additional fin that does not have a bending portion.

In a fifteenth example, a holding plate according to any of the first to fourteenth example is provided, wherein the disk-shaped plate is round and has a diameter between 2″ and 3″, preferably 2″, 2⅜″, or 3″, or wherein the disk-shaped plate is rectangular and has an edge length between 2″ and 3″, and wherein the aperture has a diameter of 0.2″ to 0.32″.

In a sixteenth example, a holding plate according to any of the first to fifteenth example is provided, wherein each fin of the plurality fins has the same geometry.

In a seventeenth example, a holding plate according to any of the first to sixteenth example is provided, wherein the plurality of fins is a first plurality of fins and wherein the contour of the inner edge further comprises a second plurality of fins and wherein the fins of the first plurality of fins have a different geometry than the fins of the second plurality of fins.

In an eighteenth example, a holding plate according to the seventh example is provided, wherein the fins of the first plurality of fins have a length (L1) that is different from the length (L2) of the fins of the second plurality of fins.

In a nineteenth example, a holding plate according to the eighteenth example is provided, wherein each fin of the first plurality of fins has a length (L1) of 0.06″ to 0.08″ and each fin of the second plurality of fins has a length (L2) of 0.04″ to 0.06″.

In a twentieth example, a holding plate according to the eighteenth or nineteenth example, wherein the first plurality of fins and the second plurality of fins each comprise three fins, and wherein the fins of the first and second pluralities of fins are distributed alternately along the contour of the edge.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the scope of the appended claims.

1. A holding plate for sheet material, the holding plate comprising:
a disk-shaped plate; and
an aperture formed by an inner edge of the disk-shaped plate,
wherein the inner edge of the disk-shaped plate has a contour that comprises a plurality of fins , wherein each fin of the plurality of fins extends at least partially towards a center of the aperture, and wherein each of the plurality of fins is configured to allow a bending of the respective fin .

2. The holding plate according to claim 1, wherein the disk-shaped plate and the plurality of fins are formed integrally.

3. The holding plate according to claim 1, wherein the disk-shaped plate is made of metal.

4. The holding plate according to claim 1, wherein each of the plurality of fins comprises a bending portion configured to allow the bending of the respective fin .

5. The holding plate according to claim 4, wherein each fin of the plurality of fins further comprises a head portion extending from the bending portion towards the center of the aperture.

6. The holding plate according to claim 5, wherein
the disk-shaped plate has a first thickness (h₁),
the head portion has a second thickness (h₂) that is smaller than or equal to the first thickness (h₁),
the bending portion has a third thickness (h₃) that is smaller than the second thickness (h₂).

7. The holding plate according to claim 6, wherein each fin further comprises a body portion and wherein the bending portion extends from the body portion.

8. The holding plate according to claim 7, wherein the body portion comprises a first tapering portion in which the thickness is gradually reduced from the first thickness (h₁) to the third thickness (h₃), and wherein the head portion comprises a second tapering portion in which the thickness is gradually reduced from the second thickness (h₂) to the third thickness (h₃).

9. The holding plate according to claim 8, wherein the first and second tapering portions each comprise a surface and wherein the surfaces of the first and second tapering portions form an angle of 80°.

10. The holding plate according to claim 6, wherein the third thickness (h₃) is between 0.008″ and 0.015″.

11. The holding plate according to claim 10, wherein the first and second thicknesses (h₁, h₂) are between 0.02″ and 0.04″.

12. The holding plate according to claim 7, wherein the bending portion has a length(s) of at least 0.008″ and wherein the length represents the distance between the body portion and the head portion of a respective fin .

13. The holding plate according to claim 5, wherein the head portion of each fin of the plurality of fins comprises a shape that is one of round, drop-shaped, or pointed.

14. The holding plate according to claim 4, wherein the contour of the inner edge of the disk-shaped plate comprises at least one additional fin that does not have a bending portion.

15. The holding plate according to claim 1, wherein the disk-shaped plate is round and has a diameter between 2″ and 3″, preferably 2″, 2⅜″, or 3″, or wherein the disk-shaped plate is rectangular and has an edge length between 2″ and 3″, and wherein the aperture has a diameter of 0.2″ to 0.32″.

16. The holding plate according to claim 1, wherein each fin of the plurality fins has the same geometry.

17. The holding plate according to claim 1, wherein the plurality of fins is a first plurality of fins and wherein the contour of the inner edge further comprises a second plurality of fins and
wherein the fins of the first plurality of fins have a different geometry than the fins of the second plurality of fins.

18. The holding plate according to claim 17, wherein the fins of the first plurality of fins have a length (L₁) that is different from the length (L₂) of the fins of the second plurality of fins.

19. The holding plate according to claim 18, wherein each fin of the first plurality of fins has a length (L₁) of 0.06″ to 0.08″ and each fin of the second plurality of fins has a length (L₂) of 0.04″ to 0.06″.

20. The holding plate according to claim 18, wherein the first plurality of fins and the second plurality of fins each comprise three fins, and wherein the fins of the first and second pluralities of fins are distributed alternately along the contour of the edge.
